(19) United States
(12) Patent Application Publication
(10) Pub. No.: US 2024/0384044 A1
(43) Pub. Date: Nov. 21, 2024

(54) Blending Methods for Rigid Vinyl Polymers

(71) Applicant: ExxonMobil Technology and Engineering Company, Annandale, NJ (US)

(72) Inventors: Madelyn Bekker, Houston, TX (US); Heidi Duveskog, Wavecrest (ZA); Divann Robertson, Malmesbury (ZA); Jeffrey C. Bunquin, Houston, TX (US); Emiel de Smit, Brussels (BE); Helge Jaensch, Grimbergen (BE)

(73) Assignee: ExxonMobil Technology and Engineering Company, Annandale, NJ (US)

(21) Appl. No.: 18/686,377

(22) PCT Filed: Oct. 14, 2022
(86) PCT No.: PCT/US2022/046690

§ 371 Date: Feb. 23, 2024

Related U.S. Application Data
(60) Provisional application No. 63/262,698, filed on Oct. 19, 2021.

(51) Int. Cl. C08J 3/20; C08K 5/01; C08L 27/06; C08L 91/06

(52) U.S. Cl. CPC C08J 3/203; C08K 5/01; C08L 27/06; C08L 91/06; C08J 2327/06; C08J 2491/06; C08L 2205/06; C08L 2207/322; C08L 2310/00

(57) ABSTRACT

Blending of polyvinylchloride (PVC) and other rigid polymers may be facilitated using lubricant compositions comprising linear alpha olefins (LAOs) or compounds derived from LAOs. PVC blending methods may comprise: combining PVC and a lubricant composition to form a mixture, and blending the mixture to form a lubricated PVC blend, in which the mixture contains an effective amount of the lubricant composition to provide a fusion temperature for the lubricated PVC blend of about 190° C. or below as determined by torque rheometry at 65 rpm. The lubricant composition may comprise one or more C₁₈₊ linear alpha olefins (LAOs) having a kinematic viscosity of about 4 cSt or less at 135° C., or one or more LAO dimers formed from the one or more C₁₈₊ LAOs, the one or more LAO dimers having an internal olefin and a kinematic viscosity of about 6 cSt or less at 135° C., or reduced LAO dimers.

### FIELD

The present disclosure relates to blending methods for rigid vinyl polymers and lubricant compositions associated with the same.

### BACKGROUND

The global plastics market has been growing steadily, fueled by the rising demand and increasing plastic consumption in the construction, automotive, packaging, electrical, electronics industries.

Plastics such as polyvinyl chloride (PVC), chlorinated polyvinyl chloride (CPVC) and polyvinylidene chloride (PVDC) have been widely employed for various purposes, including the fabrication of tubing and rigid pressurized piping. PVC is particularly desirable for forming rigid tubing and piping articles because of its low cost and beneficial properties, such as exceptional corrosion resistance to acids, corrosive liquids and gases. PVC is non-contaminating and provides good pressure-bearing capability, fast and reliable solvent-welded connections, and ease of handling. Although PVC is a very versatile polymer in the foregoing respects, PVC base resin is relatively hard and brittle, which makes it very difficult to process with manufacturing equipment such as extruders, injection molders or other equipment used to process PVC materials, such as pastillators, prillers, and flakers.

Industrial processing of PVC and other rigid vinyl polymers may be facilitated by an appropriate lubricant. Lubricants are commonly used as extrusion aids that are blended with PVC base resin to facilitate processing. Lubricants may control the melting point in an extruder/molder to achieve more optimal processing characteristics and physical properties. Suitable lubricants may be external, internal, or external/internal. External lubricants (e.g., paraffin waxes, Fischer-Tropsch (FT) waxes, polyethylene waxes, and the like) may provide good surface release characteristics and lubrication between individual PVC particles and/or a surface, such as described in U.S. Pat. Nos. 5,750,608 and 5,426,144, U.S. Patent Application Publication 2008/0099730, International Patent Application Publications 2018/087277 and 2016/130863, and CN104877257). Internal lubricants may provide lubrication at the molecular level between PVC particles and reduce melt viscosity by improving inter-particle flow when the PVC is in molten form. Further, internal lubricants may reduce internal friction and promote fusion. External/internal lubricants may provide characteristics of both external and internal lubricants, depending on the specific combination of chemical groups contained therein. Common external/internal lubricants used in PVC processing may include fatty acid amides and oxidized polyethylenes.

Although lubrication may be desirable during PVC processing, conventional lubricants are not without their issues. Many commonly used lubricants are high-viscosity substances, which may hinder PVC processing. Excessively high PVC fusion temperatures may also result when using a lubricant. Moreover, it may be difficult to balance compounding conditions and lubricant amounts and properties to achieve desired PVC properties. The Plastics Pipe Institute provides guidance (PPI TR-2 2019 part A.3) concerning the amounts, chemical composition, and rheological behavior of suitable lubricants that may be used during PVC processing.

### SUMMARY

In some aspects, the present disclosure provides methods for blending polyvinyl chloride (PVC) using olefinic lubricants. The methods comprise: combining PVC and a lubricant composition to form a mixture, the lubricant composition comprising one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.; and blending the mixture to form a lubricated PVC blend, the mixture comprising an effective amount of the lubricant composition to provide a fusion temperature for the lubricated PVC blend of about 190° C. or below as determined by torque rheometry at 65 rpm.

In some or other aspects, the present disclosure provides methods for blending PVC using paraffinic lubricants. The methods comprise: combining PVC and a lubricant composition to form a mixture, the lubricant composition comprising one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; and blending the mixture to form a lubricated PVC blend, the mixture comprising an effective amount of the lubricant composition to provide a fusion temperature for the lubricated PVC blend of about 190° C. or below as determined by torque rheometry at 65 rpm.

In some aspects, lubricant compositions described herein may comprise: a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together.

In still other aspects, lubricant compositions described herein may comprise: algae oil; and one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.

These and other features and attributes of the disclosed methods and compositions of the present disclosure and their advantageous applications and/or uses will be apparent from the detailed description which follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

To assist one of ordinary skill in the relevant art in making and using the subject matter hereof, reference is made to the appended drawings, wherein:

FIG. 1 is a flow diagram of a non-limiting example method of the present disclosure.

FIG. 2 is a plot of torque as a function of time for various PVC blends containing C₂₀-C₂₄ LAOs.

FIG. 3 is a plot of torque as a function of time for PVC blends containing a 1:1 blend of algae oil and C₁₈-C₂₄ LAOs.

FIG. 4A is a plot of torque as a function of time at various temperatures for a 1:1 blend of algae oil and a Fischer-Tropsch wax (SASOLWAX H1) at 1.1 phr PVC. FIG. 4B is a plot of torque as a function of time at various temperatures for a Fischer-Tropsch wax (SASOLWAX H1) at 1.1 phr PVC.

FIG. 5 is a gas chromatography (GC) plot of a 1:1 (w/w) blend of a paraffinic hydrocarbon material and a high-melt Fischer-Tropsch wax.

FIG. 6 shows differential scanning calorimetry (DSC) plots of heat flow versus temperature for a high-melt Fischer-Tropsch wax, a paraffinic hydrocarbon material, and a 1:1 blend of paraffinic hydrocarbon material and high-melt Fischer-Tropsch wax.

FIG. 7 is a graph depicting the crystallization kinetics of a paraffinic hydrocarbon material, a high-melt Fischer-Tropsch wax, and various blends of paraffinic hydrocarbon material and high-melt Fischer-Tropsch wax.

### DETAILED DESCRIPTION

The present disclosure relates to blending methods for rigid vinyl polymers and, more specifically, lubricant compositions for blending polyvinyl chloride (PVC) and other rigid vinyl polymers.

As discussed above, rigid vinyl polymers, such as polyvinyl chloride (PVC), may have a wide range of applications. However, the rigid nature of these polymers may complicate their processing and extrusion. Lubricant compositions may facilitate processing of PVC and other rigid vinyl polymers in various respects, but currently used lubricant compositions may present various difficulties.

The present disclosure expands the range of waxy substances suitable for incorporation in lubricant compositions applicable for processing rigid vinyl polymers, such as PVC, and provides related advantages as well. Lubricant compositions of the present disclosure may be based upon linear alpha olefins (LAOs) within a specified size range or reaction products thereof (e.g., LAO dimers or reduced LAO dimers). Suitable LAOs may include C₁₈-C₂₄ LAOs and/or C₂₄₊ LAOs, and their dimers and reduced dimers (paraffinic dimers), optionally in further combination with other substances. Advantageously, LAOs and their reaction products may afford lubricant compositions having a wide range of properties, as discussed further herein, thereby affording a range of accessible PVC processing conditions from a common base material. Depending on the size of the starting LAOs and/or the type of reaction product obtained, the lubricant compositions disclosed herein may mimic conventional waxes used in PVC processing, mimic oil-based PVC lubricants, and/or provide intermediate properties in between these two types of lubricants. Blends of LAOs and Fischer-Tropsch waxes may be utilized in some instances. Additionally, LAOs and their reaction products may be combined with algae oil or other biologically sourced materials to improve the environmental impact of PVC processing and provide further PVC processing advantages as well. Algae oil may also improve the fusion performance of Fischer-Tropsch waxes alone, even when LAOs or LAO dimers are not present.

Advantageously, the lubricant compositions of the present disclosure may be tailored to facilitate PVC processing under desired conditions (e.g., lower fusion temperatures, decreased fusion times, optimized lubricant concentration levels, and the like). The foregoing may facilitate decreased PVC processing temperatures while simultaneously improving lubrication efficiency. Such tailoring may be achieved by selecting appropriate components for the lubricant compositions (e.g., particular LAOs, paraffinic hydrocarbons, or blends of LAOs and paraffinic hydrocarbons) and their associated properties (e.g., the extent of unsaturation and/or branching present in a selected lubricant composition component). Increased coverage of PVC resin particles with the lubricant compositions may be achieved in some instances, thereby resulting in increased lubrication efficiency.

The lubricant compositions of the present disclosure are solids but may advantageously provide considerable flexibility for PVC manufacturing through facilitating liquid-like lubrication performance. For example, the lubricant compositions of the present disclosure may be incorporated at relatively high concentrations and afford high lubricant mobility and fast production rates (short fusion times) of lubricated PVC, in contrast to the behavior of typical paraffinic hydrocarbon waxes. Moreover, the lubricant compositions of the present disclosure conveniently may otherwise behave in a similar manner to normal paraffin waxes and serve as external lubricants that may influence fusion behavior during PVC lubrication.

In accomplishing the foregoing, LAOs may be particularly compatible with and lower the fusion temperature achievable with typical Fischer-Tropsch waxes, thereby providing advantageous lubricant compositions. Hence, some lubricant compositions of the present disclosure may facilitate PVC processing with Fischer-Tropsch waxes at lower processing temperatures and at higher lubricant concentrations to afford greater lubrication coverage than is possible with the Fischer-Tropsch wax alone, while maintaining advantageously low processing torque values to produce less wear and tear on processing equipment. Compatibilized blends of paraffinic hydrocarbons and Fischer-Tropsch wax may also afford similar advantages herein, as discussed further hereinbelow. Blends of algae oil and Fischer-Tropsch wax may also afford advantageous PVC lubrication and fusion performance.

The lubricant compositions of the present disclosure also may incorporate renewable resources in some instances. In particular, the lubricant compositions of the present disclosure may comprise a blend of algae oil and LAOs and/or Fischer-Tropsch waxes. Such renewable lubricant compositions advantageously may provide good synergy between the algae oil and the wax(es), thus affording good fusion and lubrication properties in comparison to conventional PVC formulations. Other renewable oil sources may also be suitable in this regard.

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature) is about 23° C.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

Unless otherwise indicated, room temperature is 23° C.

As used herein, the term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Cₙ” refers to hydrocarbon(s) or a hydrocarbyl group having n carbon atom(s) per molecule or group along the main carbon chain, wherein n is a positive integer. Such hydrocarbon or hydrocarbyl groups may be one or more of linear, branched, cyclic, acyclic, saturated, unsaturated, aliphatic, or aromatic.

As used herein, the terms “hydrocarbyl” and “hydrocarbyl group” are used interchangeably herein. The term “hydrocarbyl group” refers to any C₁-C₁₀₀ hydrocarbon group bearing at least one unfilled valence position when removed from a parent compound. “Hydrocarbyl groups” may be optionally substituted, in which the term “optionally substituted” refers to replacement of at least one hydrogen atom or at least one carbon atom with a heteroatom or heteroatom functional group. Hydrocarbyl groups therefore may include alkyl, alkenyl, alkynyl, aryl, heteroaryl, cycloalkyl, heterocyclyl, and the like, any of which may be optionally-substituted.

As used herein, the terms “linear” and “linear hydrocarbon” refer to a hydrocarbon or hydrocarbyl group having a continuous carbon chain without side chain branching.

As used herein, the term “olefin,” alternatively referred to as “alkene,” is a linear, branched, or cyclic compound of carbon and hydrogen having at least one carbon-carbon double bond.

As used herein, the term “alpha olefin” refers to an olefin having a terminal carbon-carbon double bond in the structure thereof (e.g., RHC=CH₂, where R is hydrogen or a hydrocarbyl group and R is a hydrocarbyl group).

As used herein, the term “linear alpha olefin (LAO)” refers to an unbranched alkenic hydrocarbon bearing a carbon-carbon double bond at a terminal (end) carbon atom of a continuous carbon chain without side chain branching.

As used herein, the terms “branch,” “branched” and “branched hydrocarbon” refer to a hydrocarbon or hydrocarbyl group having a linear continuous carbon chain in which a hydrocarbyl side chain extends from the linear continuous carbon chain.

As used herein, the term “higher LAO” refers to LAOs having at least 6 carbon atoms.

As used herein, the term “blend” refers to a mixture of two or more components. Blends may be produced by, for example, solution blending, melt mixing, or compounding in a shear mixer. The terms “blending” and “combining” are used interchangeably herein.

As used herein, the term “Mn” is the number average molecular weight, and Mw is the weight average molecular weight. Unless otherwise noted, all molecular weight units (e.g., Mw, Mn) are expressed in g/mol.

As used herein, the term “fusion time” refers to the time (in minutes) when coalescence between solids particles begins to occur during heating.

As used herein, the term “phr” means “parts per hundred parts resin” by weight, where resin refers to PVC and the resin content is the total PVC content in a lubricated PVC blend. Thus, lubricated PVC blends of the present disclosure contain both the lubricant composition and the PVC base resin. For example, a lubricated PVC blend having 2 parts by weight lubricant composition may be referred to as having 2 phr lubricant composition. Components added to a lubricant composition are specified on a parts per hundred (pph) basis (wt. % basis).

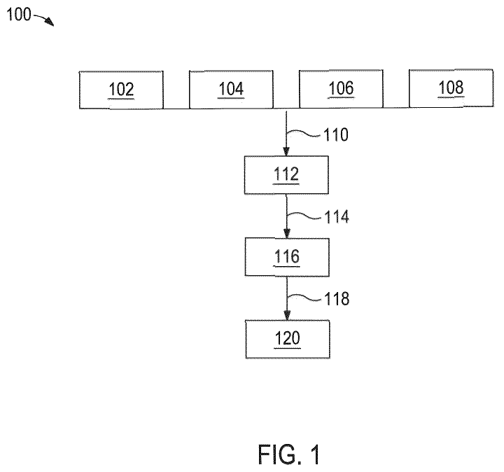

FIG. 1 is a flow diagram of non-limiting example method 100 of the present disclosure. Rigid vinyl polymer 102 (e.g., PVC) and lubricant composition 104 are combined 110 to produce mixture 112. Optionally, metal salt 106 and heat stabilizer 108 are combined 110 within mixture 112. Rigid vinyl polymer 102, lubricant composition 104, metal salt 106, and heat stabilizer 108 can be combined 110 in any order, with mixing and/or heating taking place during the process of combining 110.

Mixture 112 is then processed 114 by applying shear at or above the fusion temperature of rigid vinyl polymer 102 to form lubricated polymer blend 116 (e.g., a lubricated PVC blend). Lubricated polymer blend 116 may then be extruded or shaped 118 to form article 120 having a desired shape.

Examples of suitable lubricant compositions may include, but are not limited to, (a) one or more C₁₈₊ linear alpha olefins (LAOs) having a kinematic viscosity (ASTM D445) of about 4 cSt or less at 135° C.; (b) one or more LAO dimers formed from one or more C₁₈₊ LAOs, the one or more LAO dimers having an internal olefin and a kinematic viscosity (ASTM D445) of about 6 cSt or less at 135° C., (c) one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C.; (d) a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; (e) a blend comprising one or more C₁₈₊ LAOs and a Fischer-Tropsch wax; or (f) algae oil and one or more C₁₈₊ linear alpha olefins (LAOs) having a kinematic viscosity (ASTM D445) of about 4 cSt or less (ASTM D445) at 135° C., or one or more LAO dimers formed from the one or more C₁₈₊ LAOs, the one or more LAO dimers having an internal olefin and a kinematic viscosity (ASTM D445) of about 6 cSt or less at 135° C. The foregoing lubricant compositions are described in further detail below.

The mixture formed by blending a rigid vinyl polymer, such as PVC, and the lubricant compositions may comprise about 2 parts lubricant composition or less per 100 parts rigid vinyl polymer. More specifically, in the case of PVC, the mixture may comprise about 2 parts lubricant composition or less per 100 parts PVC. The amount of lubricant composition is non-zero. In example mixtures, about 0.5 to about 1.5 parts lubricant composition per 100 parts PVC may be present.

Example metal salts that may be present in the mixture in combination with PVC and a lubricant composition include, but are not limited to, zinc stearate, barium stearate, cadmium stearate, barium ricinolate, calcium oleate, calcium laurate, zinc octanoate, and mixtures thereof. In particular examples, the metal salt may comprise a mixture of barium stearate, zinc stearate, or cadmium stearate with another metal salt. Example metal salt mixtures may include, for instance, barium stearate/zinc stearate, calcium stearate/zinc stearate, or barium stearate/cadmium stearate

The mixture comprising the rigid vinyl polymer and the lubricant composition may further comprise the metal salt in an amount of about 2 parts metal salt or less per 100 parts rigid vinyl polymer (e.g., PVC). In the case of PVC, illustrative metal salt quantities (per 100 parts PVC resin by weight) may include, for example, about 0.1 parts to about 1.5 parts, or about 0.2 parts to about 1 parts, or about 0.3 parts to about 0.9 parts, or about 0.4 parts to about 0.8 parts.

The mixture formed by blending a rigid vinyl polymer, such as PVC, and the lubricant compositions may comprise a heat stabilizer, such as an organotin compound. Illustrative organotin compounds that may function as heat stabilizers include, for example, methyltin, butyltin, octyltin, tin dilaurate, dibutyl tin maleate, organic tin mercaptides, organic tin sulfonic amide, the like, and any mixture thereof.

The mixture comprising the rigid vinyl polymer and the lubricant composition may further comprise the heat stabilizer in an amount of about 2 parts metal salt or less per 100 parts rigid vinyl polymer (e.g., PVC). In the case of PVC, illustrative heat stabilizer quantities (per 100 parts PVC resin by weight) may include, for example, about 0.1 parts to about 1.5 parts, or about 0.2 parts to about 1 parts, or about 0.3 parts to about 0.9 parts, or about 0.4 parts to about 0.8 parts.

Optionally, stabilizers such as epoxy compound stabilizers, organic phosphite stabilizers, or organotin mercaptide stabilizers may be present in the mixture of rigid vinyl polymer and lubricant composition. Epoxy compound stabilizers may include epoxy soybean oil, ESO, epoxy linseed oil, epoxy polybutadiene, epoxy methylstearate, epoxy stearate, epoxy ethylhexyl stearate, epoxy stearyl stearate, epoxy propyl isocyanalate 3-(2-case INO)-1,2-epoxy propane, bis-phenol A diglycidyl ether, vinyl dicyclohexanediepoxide, 2,2-bis-(4-hydroxyphenol) propane and epichlorohydrine condensation copolymeration, and mixtures thereof. Organic phosphite stabilizers may include diphenyldecyl phosphite, triphenyl phosphite, tris-nonylphenyl phosphite, tri-steareal phosphite, octyldiphenyl phosphite, and mixtures thereof. Suitable organotin mercaptides may include, for example, methyltin mercaptide, butyltin mercaptide, and octyltin mercaptide. Certain carboxylates may also be used.

In at least one embodiment of the present disclosure, lubricated PVC blends described herein may feature a fusion temperature of about 190° C. or below as determined by torque rheometry at 65 rpm and/or a fusion time of about 4 minutes or less as determined by torque rheometry at 65 rpm. Other fusion temperatures and fusion times accessible through use of the lubricant compositions disclosed herein include a fusion temperature of about 185° C. or below, or about 180° C., each as determined by torque rheometry at 65 rpm, and/or a fusion time of about 3 minutes or less, or about 2 minutes or less, or about 1 minute or less as determined by torque rheometry at 65 rpm. In some embodiments, lubricant compositions disclosed herein may even facilitate a fusion temperature of about 150° C. or below, such as a fusion temperature of about 145° C., as determined by torque rheometry at 65 rpm.

The present disclosure provides methods for blending PVC with lubricant compositions to produce lubricated PVC. Such methods for blending PVC may comprise: combining PVC and the lubricant composition to form a mixture, and blending the mixture to form a lubricated PVC blend. The mixture may comprise an effective amount of the lubricant composition to provide a fusion temperature for the lubricated PVC blend of about 190° C. or below as determined by torque rheometry at 65 rpm. In some embodiments, the lubricant compositions may comprise one or more C₁₈₊ linear alpha olefins (LAOs) having a kinematic viscosity (ASTM D445) of about 4 cSt or less at 135° C., or one or more LAO dimers formed from the one or more C₁₈₊ LAOs, in which the one or more LAO dimers have an internal olefin and a kinematic viscosity (ASTM D445) of about 6 cSt or less at 135° C. Optionally, the one or more C₁₈₊ LAOs may be present in combination with a Fischer-Tropsch wax in a lubricant composition. In other embodiments, the lubricant compositions may comprise one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together. In still other embodiments, the lubricant compositions disclosed herein may comprise an algae oil and one or more C₁₈₊ linear alpha olefins (LAOs) having a kinematic viscosity (ASTM D445) of about 4 cSt or less at 135° C., or one or more LAO dimers formed from the one or more LAOs, the one or more LAO dimers having an internal olefin and a kinematic viscosity (ASTM D445) of about 6 cSt or less at 135° C., or a blend of algae oil and Fischer-Tropsch wax.

Processes suitable for forming linear alpha olefins (LAOs) for use in the disclosure herein are not believed to be particularly limited. LAOs within the foregoing size ranges for forming a suitable lubricant composition may be synthesized by several different processes starting from low molecular weight feedstock materials. A primary route for synthesizing LAOs is via ethylene oligomerization, of which there are several synthetic variants that may be mediated using different Ziegler-type catalysts. Depending on the particular Ziegler-type catalyst and the synthetic conditions, ethylene oligomerization reactions may form a range of homologous LAOs having an even number of carbon atoms (i.e., C₂ₙH₂ₙ, where n is a positive integer greater than or equal to 2), or a predominant LAO (e.g., 1-butene, 1-hexene, 1-octene, or 1-decene) may be produced. When multiple LAOs are formed, the product distribution of the LAOs may follow a Schulz-Flory distribution, with the distribution being arranged about a central molecular weight. Such processes are commonly referred to as full-range or wide-range LAO synthesis processes. LAO syntheses affording a predominant LAO (e.g., about 70% or more or even about 90% or more of the LAOs in the product stream) may also form up to about 10 wt. % of other minor product LAOs and additional byproducts. Such LAO syntheses are referred to herein as being “specific” LAO syntheses, and they may sometimes be referred to in the art as “on-purpose” LAO syntheses.

Fractional distillation processes are frequently employed to separate LAO product streams into desired fractions comprising individual or multiple LAOs. Typical distillation processes for separating LAOs from one another may employ a two-product distillation column to isolate an overhead stream comprising an individual LAO or LAO mixture and a bottoms stream comprising a mixture of LAOs having higher boiling points than those obtained in the overhead stream. This process is iterated until LAOs up to a desired carbon count have been separated from one another. In the case of the present disclosure, C₁₈-C₂₄ or C₂₀-C₂₄ LAOs may be obtained as an overhead stream during distillation and C₂₄₊ LAOs may be obtained separately as a bottoms stream. The LAOs in each fraction may have an even carbon count (i.e., contain C₂ₙ carbon atoms, wherein n is an integer greater than or equal to 2).

Suitable lubricants may also be obtained through dimerization of C₁₈-C₂₄, C₂₀-C₂₄, or C₂₄₊ LAOs to obtain LAO dimers having 2n−2 carbon atoms, wherein n is the number of carbon atoms in the LAOs undergoing dimerization. Sources for the LAOs undergoing dimerization may include any of those described above, such as but not limited to, LAOs obtained from ethylene oligomerization, fatty alcohol dehydration, renewable/biomass-derived LAOs (e.g., obtained from lactones, unsaturated fatty acids, ethanol, or the like), or any combination of these. Dimerization may occur through a metathesis process in the presence of a suitable metal carbene catalyst, resulting in loss of ethylene and formation of a linear olefin dimer having an internal double bond. Dimerization may take place in a continuous mode, such as in a continuous stirred tank reactor or a tubular reactor.

The lubricant compositions of the present disclosure may comprise: (a) one or more C₁₈₊ linear alpha olefins (LAOs) having a kinematic viscosity (ASTM D445) of about 4 cSt or less at 135° C., such as from about 1 cSt to about 4 cSt, or about 1 cSt to about 3.5 cSt at 135° C.; (b) one or more LAO dimers formed from one or more C₁₈₊ LAOs, the one or more LAO dimers having an internal olefin and a kinematic viscosity (ASTM D445) of about 6 cSt or less at 135° C.; (c) one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity before dimerization of about 4 cSt or less at 135° C.; (d) a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; (e) a blend comprising one or more C₁₈₊ LAOs and a Fischer-Tropsch wax; or (f) an algae oil and one or more C₁₈₊ linear alpha olefins (LAOs) having a kinematic viscosity (ASTM D445) of about 4 cSt or less at 135° C., or one or more LAO dimers formed from the one or more LAOs, the one or more LAO dimers having an internal olefin and a kinematic viscosity (ASTM D445) of about 6 cSt or less at 135° C.

C₁₈₊ LAOs that may comprise suitable lubricant compositions or serve as a precursor to suitable lubricant compositions may comprise predominantly C₁₈-C₂₄ LAOs, C₂₀-C₂₄ LAOs, or C₂₄₊ LAOs. Although C₂₀-C₂₄ and C₂₄₊ LAOs are solid waxes at room temperature, their lubrication behavior with PVC surprisingly may afford fusion times and temperatures that are more comparable with liquid lubricants, such as high-viscosity mineral oil. Without being bound by any theory or mechanism, it is believed that C₂₀-C₂₄ LAOs may afford similar fusion behavior due to the olefinic nature of the C₂₀-C₂₄ LAOs and how the terminal olefin group may interact with the PVC. Preferably, the lubricant compositions may lack LAOs of C₃₀₊ size and above.

C₂₀-C₂₄ LAOs may have a kinematic viscosity (ASTM D445) of about 5 cSt or less or about 4 cSt or less at 135° C., such as about 1 cSt to about 4 cSt at 135° C., or about 1.5 cSt to about 3.5 cSt at 135° C., or about 2 cSt to about 3 cSt at 135° C., or about 1 cSt to about 2 cSt at 135° C., or about 1 cSt to about 1.5 cSt at 135° C.; a congealing point (ASTM D938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D87) ranging from about 5° C. to about 200° C., or from about 10° C. to about 175° C., or from about 15° C. to about 150° C., or from about 20° C. to about 125° C., or from about 25° C. to about 100° C.

A sample containing C₂₀-C₂₄ LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

C₂₄₊ LAOs may have a kinematic viscosity (ASTM D445) of about 4 cSt or less or about 5 cSt or less at 135° C., such as about 1 cSt to about 4 cSt at 135° C., or about 1.5 cSt to about 3.5 cSt at 135° C., or about 2 cSt to about 3 cSt at 135° C., or about 1 cSt to about 2 cSt at 135° C., or about 1 cSt to about 1.5 cSt at 135° C.; a congealing point (ASTM D938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D87) ranging from about 5° C. to about 200° C., or from about 10° C. to about 175° C., or from about 15° C. to about 150° C., or from about 20° C. to about 125° C., or from about 25° C. to about 100° C.

A sample containing C₂₄₊ LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

The C₁₈₊ LAOs described above may be dimerized to form LAO dimers having an internal olefin, which may also be suitably incorporated in the lubricant compositions described herein. Such LAO dimers may be formed through metathesis-based dimerization and have two carbon atoms less than the two LAO molecules from which the LAO dimers are produced. The LAO dimers may have an even carbon number distribution. The LAO dimers may be further reduced (hydrogenated) to form paraffinic hydrocarbons having an even carbon number distribution, as described herein, which may also be suitably included in the lubricant compositions of the present disclosure. Suitable LAO dimers comprising an internal olefin may have a kinematic viscosity (ASTM D445) of about 3.5 cSt to about 5.5 cSt or about 4 cSt to about 5.5 cSt at 135° C. Suitable paraffinic hydrocarbons formed from such LAO dimers may feature an even carbon number distribution and a kinematic viscosity (ASTM D445) of about 8 cSt or less at 135° C., such as a kinematic viscosity (ASTM D445) of about 4 cSt to about 8 cSt at 135° C.

In some embodiments, the lubricant compositions of the present disclosure may comprise C₁₈₊ LAOs or LAO dimers, and a Fischer-Tropsch wax. A suitable ratio of Fischer-Tropsch wax:C₁₈₊ LAOs or Fischer-Tropsch wax:LAO dimers may range from about 1:1 to about 1:9 on a weight basis. Such lubricant compositions may have a carbon number distribution with both even and odd carbon numbers, wherein even carbon numbers are in higher abundance due to the presence of the LAOs or LAO dimers.

Alternately, the lubricant compositions of the present disclosure may comprise a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together. When endothermic melting peaks are at least partially merged together in a paraffinic hydrocarbon blend, the melting peaks for each individual component in the paraffinic hydrocarbon blend (e.g., the paraffinic hydrocarbon wax and the Fischer-Tropsch wax) occur closer in temperature to one another than they do in separate DSC curves obtained for each component. Suitable paraffinic hydrocarbon waxes that may be suitably combined with a Fischer-Tropsch waxes to afford merging of endothermic melting peaks may contain a continuous carbon distribution containing both even and odd carbon numbers, in which there is no particular enhancement of the even carbon numbers.

Examples of suitable paraffinic hydrocarbon waxes that may be combined with Fischer-Tropsch waxes in a lubricant composition to accomplish the foregoing may include paraffin waxes with any one of low-(about 55° C. or less), mid-(about 55° C. to about 80° C.), or high-range (above about 80° C.) melting points. Illustrative paraffinic hydrocarbon waxes that may be suitable include, but are not limited to, PARVAN™ 1580 (available from ExxonMobil), RHEOLUB® RL165 and RHEOLUB® RL250 (available from Honeywell Industries). Other suitable paraffinic hydrocarbon waxes may include, for example, INTERFLO 66 and INTERFLO L-6530b from International Group, SYNERTIVE RX-165 and SYNERTIVE RX-170 from Rheogistics LLC, MR7073 and MR7173 from Masterank Wax, Inc., PETRAC 165 and PETRAC 200 from Valtris Specialty Chemicals, and REALUBE RW70 and RW73 from Reagens.

In some embodiments, lubricant compositions of the present disclosure may comprise a blend of algae oil and Fischer-Tropsch wax. The ratio of algae oil to Fischer-Tropsch wax may range from about 1:9 to about 9:1 on a weight basis. Such lubricant compositions may be utilized in PVC fusion methods in a similar manner to that described herein for other lubricant compositions. Other bio-derived oils, including those described below, may be utilized instead of algae oil.

Fischer-Tropsch waxes may be produced as a by-product from the conversion of natural gas or gasification of coal under known conditions to produce synthesis gas (CO+H₂). Common Fischer-Tropsch waxes may have a melting point of about 75° C. or greater and/or feature a carbon count of about C₁₉₊ or higher. Illustrative Fischer-Tropsch waxes may include, but are not limited to, high-melting Fischer-Tropsch waxes such as SASOLWAX C80, SASOLWAX™ B52, SASOLWAX6600™, SASOLWAX6800™, and SASOLWAX™ H1 (available from Sasol). Functionalized Fischer-Tropsch waxes may be suitable in some instances.

In addition to the paraffinic hydrocarbon wax having a Cₙ carbon number distribution, the paraffinic hydrocarbon wax may include about 30% branched paraffins or greater, or about 35% branched paraffins or greater, or about 40% branched paraffins, or about 45% branched paraffins or greater, or about 50% branched paraffins or greater, or about 55% branched paraffins or greater, or about 60% branched paraffins or greater, on a weight basis.

Paraffinic wax may constitute a majority of the paraffinic hydrocarbon blend. The paraffinic hydrocarbon blend may comprise a ratio of paraffinic hydrocarbon wax to Fischer-Tropsch wax in a range of about 9:1 to about 1:1 on a weight basis, such as a ratio of about 8:1 to about 1:1, or about 7:1 to about 1:1, or about 6:1 to about 1:1, or about 5:1 to about 1:1, or about 4:1 to about 1:1, or about 3:1 to about 1:1, or about 2:1 to about 1:1. Such paraffinic hydrocarbon blends may have a kinematic viscosity (ASTM D445) of about 4.5 cSt to about 7 cSt at 135° C.

In at least one embodiment, the lubricant compositions of the present disclosure may comprise a paraffinic hydrocarbon blend comprising PARVAN® 1580 (a paraffinic hydrocarbon wax) and SASOLWAX™ H1 or SASOLWAX L6800 (each a Fischer-Tropsch wax) at any of the foregoing ratios. Such paraffinic hydrocarbon blends may exhibit endothermic melting peaks by differential scanning calorimetry (DSC) that are at least partially merged together.

Optionally, suitable lubricant compositions of the present disclosure may comprise a bio-derived oil as well, such as an algae oil. Suitable algae oils may be obtained through bio-extraction of various types of algae and may comprise at least omega-3 and/or omega-9 fatty acids. Additional examples of suitable algae oils and their components may be found in U.S. Pat. No. 9,228,155, U.S. Patent Application Publication 2015/0005420, and International Patent Application Publication 2016/130863, each of which is incorporated herein by reference. Other bio-derived oils may also be suitable, such as fish oil, krill oil, cod liver oil, seaweed oil, and vegetable oil (e.g., soy oil, canola oil, rapeseed oil, palm oil, jatropha oil, the like, or any combination thereof), or any combination thereof.

Accordingly, lubricant compositions of the present disclosure may comprise a blend comprising an algae oil and one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C., or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) of about 4 cSt or less at 135° C., or a paraffinic hydrocarbon blend comprising a paraffinic hydrocarbon wax and a Fischer-Tropsch wax, in which the paraffinic hydrocarbon blend exhibits endothermic melting peaks by differential scanning calorimetry (DSC) that are at least partially merged together. Any of the LAOs, LAO dimers, or LAO dimers that have undergone subsequent reduction may be utilized to form the foregoing.

Lubricant compositions comprising algae oil may have a ratio of algae oil to C₁₈₊ LAOs or LAO dimers ranging from about 1:1 to about 1:9 on a weight basis, or from about 1:1 to about 1:8, or from about 1:1 to about 1:7, or from about 1:1 to about 1:6, or from about 1:1 to about 1:5, or from about 1:1 to about 1:4, or from about 1:1 to about 1:3, or from about 1:1 to about 1:2, on a weight basis.

### Embodiments Disclosed Herein Include

A. Methods for blending PVC using olefinic lubricant compositions. The methods comprise: combining PVC and a lubricant composition to form a mixture, the lubricant composition comprising one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.; and blending the mixture to form a lubricated PVC blend, the mixture comprising an effective amount of the lubricant composition to provide a fusion temperature for the lubricated PVC blend of about 190° C. or below as determined by torque rheometry at 65 rpm.
A1. A lubricated PVC blend prepared by the method of A.
A2. A lubricated PVC blend comprising PVC and a lubricant composition comprising one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.
B. Methods for blending PVC using paraffinic lubricant compositions. The methods comprise: combining PVC and a lubricant composition to form a mixture, the lubricant composition comprising one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; and blending the mixture to form a lubricated PVC blend, the mixture comprising an effective amount of the lubricant composition to provide a fusion temperature for the lubricated PVC blend of about 190° C. or below as determined by torque rheometry at 65 rpm.
B1. A lubricated PVC blend prepared by the method of B.
B2. A lubricated PVC blend comprising PVC and a lubricant composition comprising one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together.
C. Lubricant compositions. The lubricant compositions comprise: a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together.
D. Bio-derived lubricant compositions. The lubricant compositions comprise: algae oil; and one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.
E. Bio-derived lubricant compositions. The lubricant compositions comprise: algae oil; and a Fischer-Tropsch wax.

Embodiments A-E may have one or more of the following additional elements in any combination:
Element 1: wherein the mixture comprises about 2 parts lubricant composition or less per 100 parts PVC.
Element 2: wherein the mixture comprises about 0.5 to about 1.5 parts lubricant composition per 100 parts PVC.
Element 3: wherein the PVC blend has a fusion time of about 4 minutes or less as determined by torque rheometry at 65 rpm.
Element 4: wherein the lubricated PVC blend further comprises a metal salt and a heat stabilizer.
Element 5: wherein the metal salt comprises calcium stearate and/or the heat stabilizer comprises an organotin compound.
Element 6: wherein the one or more C₁₈₊ LAOs comprise predominantly C₂₀-C₂₄ LAOs, or C₂₄₊ LAOs.
Element 7: wherein the one or more C₁₈₊ LAOs have a kinematic viscosity (ASTM D445) of about 1 cSt to about 4 cSt at 135° C.
Element 8: wherein the one or more LAO dimers have a kinematic viscosity (ASTM D445) of about 4 cSt to about 5.5 cSt at 135° C.
Element 9: wherein the lubricant composition further comprises an algae oil.
Element 10: wherein the lubricant composition has a ratio of algae oil:C₁₈₊ LAOs or algae oil:LAO dimers ranging from about 1:1 to about 1:9 on a weight basis.
Element 11: wherein the lubricant composition further comprises a Fischer-Tropsch wax.
Element 12: wherein the lubricant composition has a ratio of Fischer-Tropsch wax:C₁₈₊ LAOs or Fischer-Tropsch wax:LAO dimers ranging from about 1:1 to about 1:9 on a weight basis.
Element 13: wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.
Element 14: wherein the paraffinic hydrocarbon wax comprises about 30% branched paraffins or greater on a weight basis.
Element 15: wherein a ratio of paraffinic hydrocarbon wax to Fischer-Tropsch wax in the paraffinic hydrocarbon blend ranges from about 9:1 to about 1:1 on a weight basis.
Element 16: wherein the paraffinic hydrocarbon blend has a kinematic viscosity (ASTM D445) of about 4.5 cSt to about 7.5 cSt at 135° C.
Element 17: wherein the lubricant composition has a ratio of algae oil:paraffinic hydrocarbon or algae oil:paraffinic hydrocarbon blend ranging from about 1:1 to about 1:9 on a weight basis.

By way of non-limiting example, illustrative combinations applicable to one or more of A-E may include, but are not limited to, 1 or 2, and 3; 1 or 2, and 6; 1 or 2, and 7; 1 or 2, and 8; 1 or 2, and 9; 1 or 2, and 10; 1 or 2, and 11; 1 or 2, 11 and 12; 6 and 7; 6 and 9; 6, 7 and 9; 6 and 11; 6, 11 and 12; 7 and 9; 7 and 11; 7, 11 and 12; 8 and 9; 1 or 2, and 12; 1 or 2, and 13; 1 or 2, and 14; 1 or 2, and 15; 1 or 2, and 16; 1 or 2, 9 and 17; 12 and 13; 12 and 14; 12 and 15; 12 and 16; 13 and 14; 13 and 15; 13 and 16; 9, 13 and 17; 14 and 15; and 14 and 16.

### EMBODIMENTS

The present disclosure is further directed to the following non-limiting embodiments:
Embodiment 1. A method for blending polyvinyl chloride (PVC), comprising: combining PVC and a lubricant composition to form a mixture, the lubricant composition comprising one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.; and blending the mixture to form a lubricated PVC blend, the mixture comprising an effective amount of the lubricant composition to provide a fusion temperature for the lubricated PVC blend of about 190° C. or below as determined by torque rheometry at 65 rpm.
Embodiment 2. The method of Embodiment 1, wherein the mixture comprises about 2 parts lubricant composition or less per 100 parts PVC.
Embodiment 3. The method of Embodiment 2, wherein the mixture comprises about 0.5 to about 1.5 parts lubricant composition per 100 parts PVC.
Embodiment 4. The method of any one of Embodiments 1-3, wherein the PVC blend has a fusion time of about 4 minutes or less as determined by torque rheometry at 65 rpm.
Embodiment 5. The method of any one of Embodiments 1-4, wherein the lubricated PVC blend further comprises a metal salt and a heat stabilizer.
Embodiment 6. The method of Embodiment 5, wherein the metal salt comprises calcium stearate and/or the heat stabilizer comprises an organotin compound.
Embodiment 7. The method of any one of Embodiments 1-6, wherein the one or more C₁₈₊ LAOs comprise predominantly C₂₀-C₂₄ LAOs, or C₂₄₊ LAOs.
Embodiment 8. The method of any one of Embodiments 1-7, wherein the one or more C₁₈₊ LAOs have a kinematic viscosity (ASTM D445) of about 1 cSt to about 4 cSt at 135° C.
Embodiment 9. The method of any one of Embodiments 1-7, wherein the one or more LAO dimers have a kinematic viscosity (ASTM D445) of about 4 cSt to about 5.5 cSt at 135° C.
Embodiment 10. The method of any one of Embodiments 1-9, wherein the lubricant composition further comprises an algae oil.
Embodiment 11. The method of Embodiment 10, wherein the lubricant composition has a ratio of algae oil:C₁₈₊ LAOs or algae oil:LAO dimers ranging from about 1:1 to about 1:9 on a weight basis.
Embodiment 12. The method of any one of Embodiments 1-9, wherein the lubricant composition further comprises a Fischer-Tropsch wax.
Embodiment 13. The method of Embodiment 12, wherein the lubricant composition has a ratio of Fischer-Tropsch wax:C₁₈₊ LAOs or Fischer-Tropsch wax:LAO dimers ranging from about 1:1 to about 1:9 on a weight basis.
Embodiment 14. A method for blending polyvinyl chloride (PVC), comprising: combining PVC and a lubricant composition to form a mixture, the lubricant composition comprising one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; and blending the mixture to form a lubricated PVC blend, the mixture comprising an effective amount of the lubricant composition to provide a fusion temperature for the lubricated PVC blend of about 190° C. or below as determined by torque rheometry at 65 rpm.
Embodiment 15. The method of Embodiment 14, wherein the mixture comprises about 2 parts lubricant composition or less per 100 parts PVC.
Embodiment 16. The method of Embodiment 14, wherein the mixture comprises about 0.5 to about 1.5 parts lubricant composition per 100 parts PVC.
Embodiment 17. The method of any one of Embodiments 14-16, wherein the PVC blend has a fusion time of about 4 minutes or less as determined by torque rheometry at 65 rpm.
Embodiment 18. The method of any one of Embodiments 14-17, wherein the lubricated PVC blend further comprises a metal salt and a heat stabilizer.
Embodiment 19. The method of Embodiment 18, wherein the metal salt comprises calcium stearate and/or the heat stabilizer comprises an organotin compound.
Embodiment 20. The method of any one of Embodiments 14-19, wherein the one or more C₁₈₊ LAOs comprise predominantly C₂₀-C₂₄ LAOs, or C₂₄₊ LAOs.
Embodiment 21. The method of any one of Embodiments 14-20, wherein the lubricant composition has a kinematic viscosity (ASTM D445) of about 8 cSt or less at 135° C.
Embodiment 22. The method of any one of Embodiments 14-21, wherein the one or more C₁₈₊ LAOs have a kinematic viscosity (ASTM D445) of about 1 cSt to about 4 cSt at 135° C.
Embodiment 23. The method of Embodiment 22, wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.
Embodiment 24. The method of any one of Embodiments 14-23, wherein the paraffinic hydrocarbon wax comprises about 30% branched paraffins or greater on a weight basis.
Embodiment 25. The method of any one of Embodiments 14-24, wherein a ratio of paraffinic hydrocarbon wax to Fischer-Tropsch wax in the paraffinic hydrocarbon blend ranges from about 9:1 to about 1:1 on a weight basis.
Embodiment 26. The method of Embodiment 24 or Embodiment 25, wherein the paraffinic hydrocarbon blend has a kinematic viscosity (ASTM D445) of about 4.5 cSt to about 7.5 cSt at 135° C.
Embodiment 27. The method of any one of Embodiments 14-26, wherein the lubricant composition further comprises an algae oil.
Embodiment 28. The method of Embodiment 27, wherein the lubricant composition has a ratio of algae oil:paraffinic hydrocarbon or algae oil:paraffinic hydrocarbon blend ranging from about 1:1 to about 1:9 on a weight basis.
Embodiment 29. A lubricant composition comprising: a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together.
Embodiment 30. The lubricant composition of Embodiment 29, wherein the paraffinic hydrocarbon wax comprises about 30% branched paraffins or greater on a weight basis.
Embodiment 31. The lubricant composition of Embodiment 29 or Embodiment 30, wherein a ratio of paraffinic hydrocarbon wax to Fischer-Tropsch wax in the paraffinic hydrocarbon blend ranges from about 1:1 to about 9:1 on a weight basis.
Embodiment 32. The lubricant composition of any one of Embodiments 29-31, wherein the paraffinic hydrocarbon blend has a kinematic viscosity (ASTM D445) of about 4.5 cSt to about 7.5 cSt at 135° C.
Embodiment 33. A lubricant composition comprising: algae oil; and one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.
Embodiment 34. The lubricant composition of Embodiment 33, wherein the lubricant composition has a ratio of algae oil:C₁₈₊ LAOs or algae oil:LAO dimers ranging from about 1:1 to about 1:9 on a weight basis.
Embodiment 35. The lubricant composition of Embodiment 33 or Embodiment 34, wherein the one or more C₁₈₊ LAOs comprise predominantly C₂₀-C₂₄ LAOs, or C₂₄₊ LAOs.
Embodiment 36. The lubricant composition of any one of Embodiments 33-35, wherein the one or more C₁₈₊ LAOs have a kinematic viscosity (ASTM D445) of about 1 cSt to about 4 cSt at 135° C.
Embodiment 37. The lubricant composition of any one of Embodiments 33-35, wherein the one or more LAO dimers have a kinematic viscosity (ASTM D445) of about 4 cSt to about 5.5 cSt at 135° C.

To facilitate a better understanding of the embodiments of the present disclosure, the following examples of preferred or representative embodiments are given. In no way should the following examples be read to limit, or to define, the scope of the invention.

### EXAMPLES

Polyvinyl chloride resin (product SE-950) was obtained from Shintech. Calcium stearate (DOVERLUBE® CA-21) was obtained from Dover Chemical Company. Methyltin mercaptide (MARK® 1925) was obtained from Galata Chemicals. Titanium dioxide (HITOX®) was obtained from TOR Minerals. PARVAN™ 1580 is a high-melting paraffin wax available from ExxonMobil Chemical Company. HYDROBRITE® PVC white mineral oil was obtained from Sonneborn. NEODENE™ 2024 (Shell Oil Company) was used as a source of LAOs (base product is predominantly C₂₀-C₂₄ LAOs and <7% C_{18 -} LAOs). SASOLWAX C80 Fischer-Tropsch hard wax, SASOLWAX™ H1 Fischer-Tropsch hard wax, and SASOLWAX B52 Fischer-Tropsch hard wax were obtained from Sasol. RHEOLUB® RL 165 and RHEOLUBR RL 250 hydrocarbon waxes were obtained from Honeywell. C₁₈-C₂₄ and C₂₄₊ LAO fractions were obtained through fractional distillation. LAO dimerization was conducted by metathesis through exposure of an LAO fraction to a metal carbene catalyst. LAO dimers were catalytically hydrogenated to the corresponding paraffinic dimers in some cases.

A 1-gallon continuous stirred-tank reactor (CSTR) made of SS316 low carbon stainless steel was used as the metathesis reactor. Prior to use, the reactor was thoroughly flushed and cleaned with dewatered toluene and then flushed with purified LAOs. The reactor was subsequently passivated with hot toluene at about 95° C. by circulating the hot toluene through the system for about 4 to 5 hours. The LAO feeds were degassed inline using vacuum to remove any remaining dissolved gasses. The LAO feeds were further purified by passage through a hybrid adsorbent bed of AZ-300 molecular sieves (Honeywell-UOP) for impurity removal (e.g., sulfur, oxygen, ethylene, peroxides, and other heteroatoms). The AZ-300 was pre-activated under N₂ at 250° C. for about 8 hours prior to use.

Olefin metathesis was conducted in the presence of a metal carbene catalyst such as Grubbs Catalyst™ 2nd Generation (Gr II) (MW=849 g/mol), Hoveyda-Grubbs Catalyst™ 2nd Generation (HGr II) (MW=627 g/mol), or Schrock Mo carbene catalyst. The metal carbene catalysts were used either in solution (previously dissolved in toluene), as a dry powder, or as a slurry mixed with SPECTRASYN™ 4, a polyalphaolefin synthetic basestock (ExxonMobil Chemicals), also referred to as a Group IV base oil according to the API Base Oil Classification system, without any prior activation process. Homogeneous catalyst solutions were prepared in a glove box under N₂ at room temperature by dissolving the metal carbene catalyst (initially in a powder form) in purified, dewatered toluene. The catalyst solutions were protected from moisture and stored at about 4° C. in a refrigerator. Catalyst suspensions were also prepared using, for example, the metal carbene catalyst powder dispersed in a low viscosity polyalphaolefin (e.g., viscosity of 2-10 cSt, such as 2, 4 or 6 cSt), or a hydrogenated olefin dimer, such as, for example, a hydrogenated C₂₆ dimer (prepared from a C₁₄ LAO via a metathesis reaction according to the disclosure herein, followed by hydrogenation). Aromatic solvents, such as toluene, may be excluded from the reaction by using a polyalphaolefin catalyst dispersant.

The catalyst solution in toluene was delivered sub-surface to the reactor via a dip tube using a dedicated metering pump. The catalyst solution was stirred continuously in a separate vessel prior to delivery. Reactions were conducted at a temperature of about 60° C. to about 75° C. at a pressure of about 10-25 psi. The reaction temperature was usually limited to about 60° C. to about 65° C. to limit double bond migration.

Ethylene produced during the metathesis reaction was removed from the reactor while continuing to form dimer. Ethylene removal was accomplished with N₂ sparging at a rate of about 2-3 L/min. Any remaining transition metal residues and catalyst debris present in the finished product were removed using silica, Celite®, or other filtration media. Unconverted monomers and other light products were removed by distillation of the reactor effluent to afford purified linear olefin dimers.

The corresponding paraffinic dimers were formed by slurry hydrogenation under the following hydrogenation conditions: 0.5 wt. % Ni powder catalyst, temperature=230° C., pressure=300 psig (20.68 barg) and 1-2 hours of contact time. After hydrogenation, the Ni catalyst was removed by filtration. Hydrogenation also may be conducted using a heterogeneous Ni or Pt catalysis, or in a batch autoclave reactor using a heterogeneous Pd on carbon catalyst.

General PVC pipe formulations. Pre-weighed PVC formulations (65 g) were formulated as specified in Table 1 and transferred to a pre-heated mixing chamber of a Haake RHEOMIX mixer. Analyses were conducted at 65 rpm until a distinct onset of degradation was observed, at which point the screw rotation was stopped. The sample was then removed, and the mixing chamber was properly cleaned before the following sample was introduced. Lubricant compositions were formulated as specified further below.

TABLE 1

| PVC | Lubricant | Calcium | Heat | |
|---|---|---|---|---|
| resin | Composition | Stearate | stabilizer | TiO₂ |
| (phr) | (phr) | (phr) | (phr) | (phr) |
| 100 | 1.0 and 1.5 | 0.6 | 0.6 | 0.5 |
| 100 | 0.7, 0.9, 1.1, | 0.6 | 0.6 | 0.5 |
| | and 1.3 | | | |

In the examples below, various LAO-based materials were evaluated for PVC lubrication performance, such as C₁₈-C₂₄ LAOs, C₂₄₊ LAOs, C₁₈-C₂₄ LAO dimers, C₂₄₊ LAO dimers, C₁₈-C₂₄ paraffin dimers, C₂₄₊ paraffin dimers, and blends of paraffinic hydrocarbons (including C₁₈-C₂₄ LAOs) and Fischer-Tropsch waxes. Renewable lubricant compositions comprising algae oil were also evaluated.

Table 2 summarizes the physical properties of various lubricant compositions that may be blended with PVC resin according to the disclosure above.

TABLE 2

| | | | Kinematic | Needle | |
|---|---|---|---|---|---|
| | Congealing | Melting | Viscosity | Penetration | Oil |
| | point | Point | at 135° C. | at 25° C. | Content |
| | (° C.) | (° C.) | (cSt) | (dmm) | (wt. %) |
| | ASTM Test Method | | | | |
| Sample | D938 | D87 | D445 | D1321 | D721 |
| PARVAN ™ 1580 | 70 | 71 | 4.3 | 15 | 0.6 |
| (Comparative Sample) | | | | | |
| RHEOLUB ® RL165 | 65 | 69 | 4.3 | 14 | 0.8 |
| (Comparative Sample) | | | | | |
| RHEOLUB ® RL250 | 70 | 72 | 4.8 | 15 | 0.7 |
| (Comparative Sample) | | | | | |
| HYDROBRITE ® PVC oil | — | — | 5.0 | — | — |
| (Comparative Sample) | | | | | |
| SASOLWAX L6800 | 97 | 112 | 8.0 | <1 | 0.2 |
| Fischer-Tropsch wax | | | | | |
| (Comparative Sample) | | | | | |
| SASOLWAX L6600 | 82 | 80 | 5.0 | 5 | 0.6 |
| Fischer-Tropsch wax | | | | | |
| (Comparative Sample) | | | | | |
| SASOLWAX B52 | 102 | 109 | 12.0 | <1 | 0.1 |
| Fischer-Tropsch wax | | | | | |
| (Comparative Sample) | | | | | |
| C₂₄₊ LAOs | 60 | 64 | 3.7 | 14 | — |
| (Experimental Sample) | | | | | |
| C₂₀-C₂₄ LAOs | 30 | 30 | 1.0 | — | — |
| (Experimental Sample) | | | | | |
| C₃₄-C₄₆ LAO | 57 | 58 | 4.0 | 35 | 6.0 |
| dimers obtained | | | | | |
| from C₁₈-C₂₄ LAOs | | | | | |
| (Experimental Sample) | | | | | |
| C₃₄-C₄₆ paraffins | 76 | 78 | 4.2 | 25 | 5.1 |
| obtained from C₁₈-C₂₄ | | | | | |
| LAOs via dimerization | | | | | |
| and hydrogenation | | | | | |
| (Experimental Sample) | | | | | |
| C₄₆₊ LAO dimers | 78 | 80 | 5.2 | 10 | 3.1 |
| obtained from C₂₄₊ LAOs | | | | | |
| (Experimental Sample) | | | | | |
| C₄₆₊ paraffins | 90 | 88 | 7.5 | 17 | 1.9 |
| obtained from C₄₆₊ | | | | | |
| LAOs via dimerization | | | | | |
| and hydrogenation | | | | | |
| (Experimental Sample) | | | | | |
| 1:1 (w/w) blend of | 88 | 90 | 9.6 | 6 | 2.2 |
| C₁₈-C₂₄ LAOs and | | | | | |
| Fischer-Tropsch wax | | | | | |
| (Experimental Sample) | | | | | |
| 1:1 (w/w) blend of | — | — | — | — | — |
| algae oil:C₂₀-C₂₄ LAOs | | | | | |
| (Experimental Sample) | | | | | |
| 1:1 (w/w) blend of | 93 | 104 | 7.1 | 8 | 0.6 |
| PARVAN ® 1580 and | | | | | |
| high-melt Fischer- | | | | | |
| Tropsch wax | | | | | |
| (Experimental Sample) | | | | | |

Table 3 below summarizes the fusion behavior obtained when lubricant compositions containing LAOs were blended with various PVC base formulations (Table 1). The lubricant compositions were incorporated as a direct replacement for PPI TR-2 2019 Part 5 A.3-type waxes in the PVC base formulations.

TABLE 3

| | Fusion Time (min) | | | | |
|---|---|---|---|---|---|
| | Average | | | | |
| | Part | | | | |
| Processing | A.3-Type | C₂₄₊ | C₁₈-C₂₄ | HYDROBRITE ® | HYDROBRITE ® |
| Temperature | Lubricant | LAOs | LAOs | PVC oil | PVC oil |
| (° C.) | @ 1 phr | @ 1 phr | @ 1 phr | @ 1 phr | @ 1.5 phr |
| 145 | — | — | 4 | — | — |
| 165 | — | — | 2 | — | — |
| 180 | 4.5 | 2 | 1 | 1 | 3 |
| 187.5 | 3 | 1 | 0.8 | — | 2 |
| 190 | 2 | — | — | — | 1.5 |

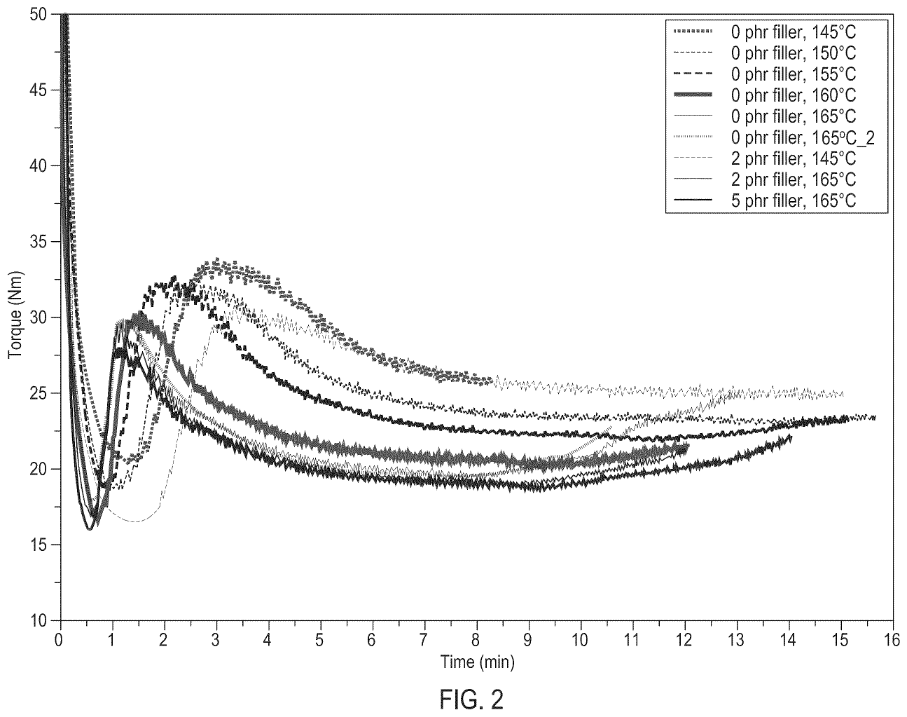

As shown, both C₁₈-C₂₄ LAOs and C₂₄₊ LAOs afforded faster fusion times did than an average PPI TR-2 2019 Part A.3-type wax when utilized at the same concentration. For at least C₁₈-C₂₄ LAOs, this result is particularly surprising, since PPI TR-2 2019 Part A.3 guidance specifies use of less than 20% C₂₆-hydrocarbons by weight, as well as hydrocarbons having a much higher viscosity (5.5-7.5 cSt at 135° C.) than are shown by either C₁₈-C₂₄ LAOs or C₂₄₊ LAOs. Moreover, C₁₈-C₂₄ LAOs performed similarly to PVC oil when utilized at the same lubricant concentration and fusion temperature, but without the downside associated with the latter. Surface distribution and PVC coverage was about the same with both types of LAO-based lubricants, as evaluated by SEM images (not shown). Without being bound by any theory, it is believed that the similar behavior of LAOs to higher viscosity PVC oils may be due to the presence of the olefinic bond in the LAOs. The low viscosity of C₁₈-C₂₄ LAOs or C₂₄₊ LAOs may allow higher loadings to be realized in PVC blends than are possible with PVC oils, thereby offering the potential of even shorter fusion times. For example, FIG. 2 is a plot of torque as a function of time for various PVC blends containing C₂₀-C₂₄ LAOs, which demonstrates that fusion may take place at a temperature at least as low as 145° C. under suitable circumstances. The loading of C₂₀-C₂₄ LAOs in FIG. 2 was 1.1 phr, and various loadings of filler are indicated in the legend of FIG. 2. The corresponding fusion times at 145° C. and 165° C. are also shown in Table 3.

Table 4 below summarizes the fusion behavior obtained when lubricant compositions containing LAO dimers and hydrogenated variants thereof were blended with the PVC base formulations (Table 1). The lubricant compositions were incorporated as a direct replacement for PPI TR-2 2019 Part A.3-type waxes in the PVC base formulations.

TABLE 4

| | Fusion Time (min) | | | | |
|---|---|---|---|---|---|
| | Average | | | | |
| | Part | C₃₄-C₄₆ | C₃₄-C₄₆ paraffins | C₄₆₊ | C₄₆₊ |
| Processing | A.3-Type | LAO | obtained from | LAO | LAO |
| Temperature | Lubricant | dimers | C₁₈-C₂₄ LAOs | dimers | dimers |
| (° C.) | @ 1.1 phr | @ 1.1 phr | @ 1.1 phr | @ 1.1 phr | @ 0.9 phr |
| 185 | 3 | 3 | — | — | — |
| 190 | 2 | 2 | 5 | no fusion | 4.5 |
| 195 | — | — | — | — | — |

| | Fusion Time (min) | | | | |
|---|---|---|---|---|---|
| | | | | | 1:1 Blend of |
| | C₄₆₊ paraffins | C₄₆₊ paraffins | | | C₁₈-C₂₄ LAOs |
| Processing | obtained from | obtained from | Fischer- | Fischer- | and Fischer- |
| Temperature | C₁₈-C₂₄ LAOs | C₁₈-C₂₄ LAOs | Tropsch Wax | Tropsch Wax | Tropsch Wax |
| (° C.) | @ 1.1 phr | @ 0.9 phr | @ 1.1 phr | @ 0.9 phr | @ 0.9 phr |
| 185 | — | — | — | — | 3 |
| 190 | no fusion | — | no fusion | no fusion | — |
| 195 | — | 3 | — | 3 | — |

As shown in Table 4, C₃₄-C₄₆ LAO dimers surprisingly displayed similar fusion behavior to conventional paraffinic hydrocarbon waxes, despite the higher viscosity and internal olefin present in the former. The corresponding C₃₄-C₄₆ paraffins obtained via hydrogenation, in contrast, led to an increased fusion time when incorporated at the same concentration. The fact that fusion occurred at all with the C₃₄-C₄₆ paraffins is surprising, given that Fischer-Tropsch waxes in the same size range did not promote PVC fusion at all under similar conditions. C₄₆₊ LAO dimers afforded fusion behavior somewhat similar to that of Fischer-Tropsch waxes. At a lubricant composition loading of 1.1 phr, neither C₄₆₊ LAO dimers nor Fischer-Tropsch waxes afforded PVC fusion at 190° C. Upon lowering the lubricant composition loading to 0.9 phr, C₄₆₊ LAO dimers afforded PVC fusion at 190° C., whereas the Fischer-Tropsch wax still did not.

C₃₄-C₄₆ paraffins and C₄₆₊ LAO dimers afforded fusion behavior intermediate between the extremes of conventional paraffinic hydrocarbon waxes and Fischer-Tropsch waxes. Thus, such lubricant compositions may offer properties to PVC manufacturers that are not available for current PVC blends.

When C₁₈-C₂₄ LAOs were blended with a Fischer-Tropsch wax, the fusion temperature was advantageously lowered. Whereas a Fischer-Tropsch wax alone at 0.9 phr required a fusion temperature of 195° C., a much lower fusion temperature of 185° C. was realized when C₁₈-C₂₄ LAOs were present.

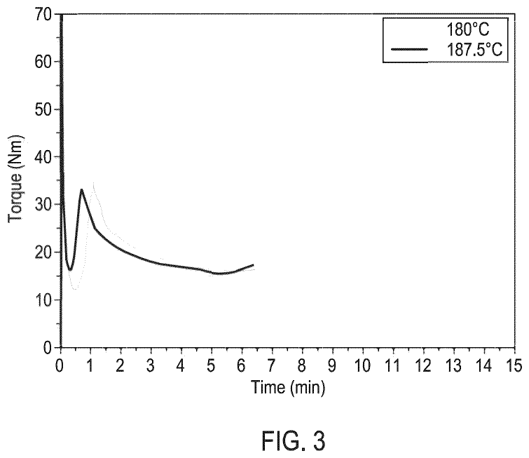

Algae oil may also be incorporated within the lubricant compositions to lower the fusion time still further. Table 5 below summarizes the fusion behavior obtained when lubricant compositions containing algae oil and C₁₈-C₂₄ LAOs (1:1 w/w blend) were combined with the PVC base formulations (Table 1). The fusion behavior of the C₁₈-C₂₄ LAOs alone and HYDROBRITE PVC white mineral oil is also presented for comparison. FIG. 3 is a plot of torque as a function of time for PVC blends containing a 1:1 blend of algae oil and C₁₈-C₂₄ LAOs at 180° C. and 187.5° C.

TABLE 5

| | Fusion Time (min) | | | |
|---|---|---|---|---|
| | Average | | | |
| | Part | | 1:1 algae | |
| Processing | A.3-Type | C₁₈-C₂₄ | oil:C₁₈-C₂₄ | HYDROBRITE |
| Temperature | Lubricant | LAOs | LAOs | PVC oil |
| (° C.) | @ 1.1 phr | @ 1.1 phr | @ 1.1 phr | @ 1.1 phr |
| 145 | — | 4 | 4.5 | — |
| 180 | 3 | 1 | 1.5 | 1 |
| 187.5 | 2 | 0.8 | 1 | 0.5 |

As shown, successful lubrication was achieved with the algae oil-containing lubricant composition, which exhibited fusion times that were only slightly longer than that of C₁₈-C₂₄ LAOs themselves and HYDROBRITE® PVC white mineral oil.

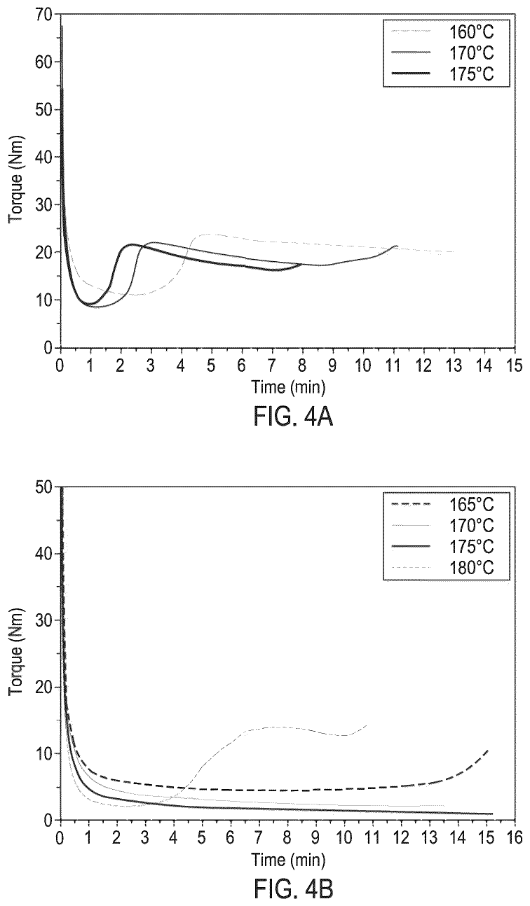

Algae oil may also be combined with a Fischer-Tropsch wax to improve fusion performance as well. FIG. 4A is a plot of torque as a function of time at various temperatures for a 1:1 blend of algae oil and a Fischer-Tropsch wax (SASOLWAX H1) at 1.1 phr PVC. As shown, effective fusion took place at temperatures ranging from 160° C. to 175° C. Effective fusion at a similar loading of the Fischer-Tropsch wax alone only occurred at a higher temperature (180° C.) (see FIG. 4B).

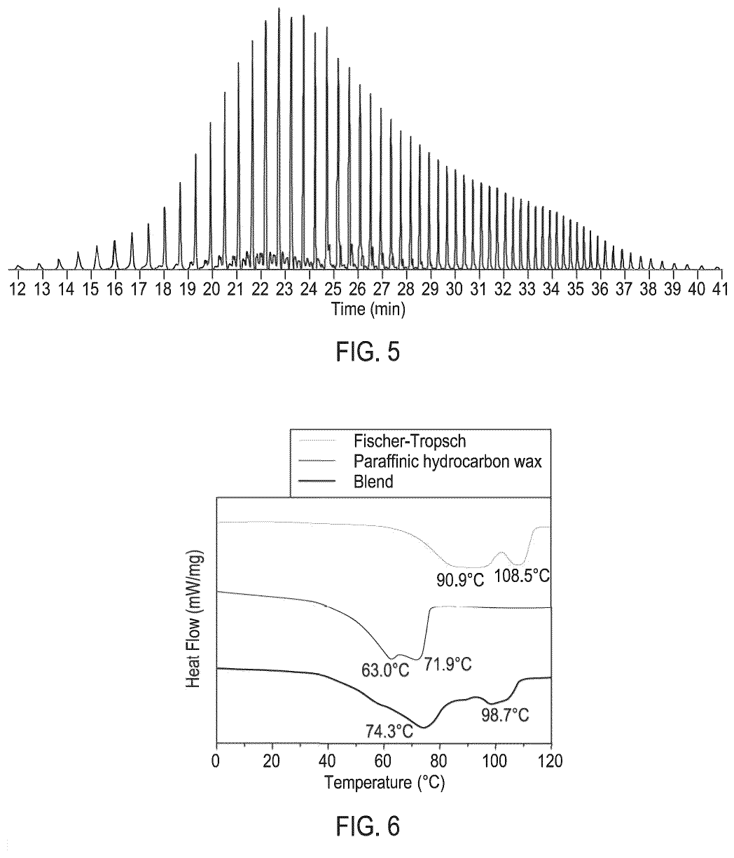

Blends of PARVAN® 1580 and high-melt Fischer-Tropsch wax (SASOLWAX H1) were also evaluated for PVC lubrication performance. FIG. 5 is a gas chromatography (GC) plot of a 1:1 (w/w) blend of PARVAN® 1580 and high-melt Fischer-Tropsch wax. The GC plot showed that the blend exhibited a gradual and consistent carbon number transition. Since LAOs were not present in this sample, there was no enhancement of even-numbered carbon components.

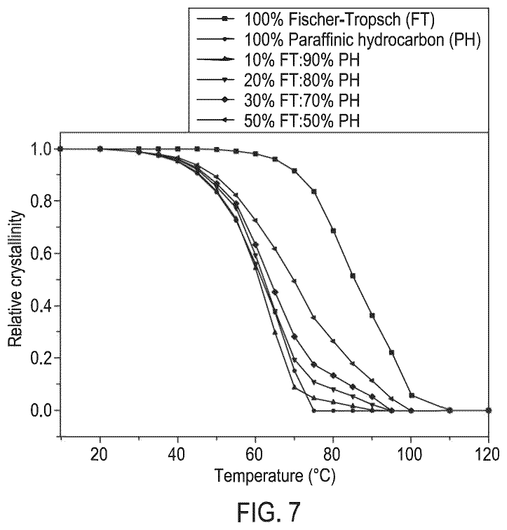

The blend of PARVAN® 1580 and high-melt Fischer-Tropsch wax exhibited surprising melting and crystallization kinetics when analyzed by differential scanning calorimetry. FIG. 6 is a differential scanning calorimetry (DSC) plot of heat flow versus temperature for the high-melt Fischer-Tropsch wax alone, PARVAN® 1580 alone, and the 1:1 blend of PARVAN® 1580 and high-melt Fischer-Tropsch wax. Surprisingly, in the blend the endothermic melting peaks of each individual component at least partially merged together (shifted toward one another). In particular, the endothermic melting peaks of PARVAN® 1580 shifted to a slightly higher temperature, and the endothermic melting peaks of the high-melt Fischer-Tropsch wax shifted to a temperature that was about 10° C. lower. The merging of endothermic melting peaks may indicate improved co-crystallization within the blend, as compared to the high-melt Fischer-Tropsch wax or PARVAN® 1580 alone. FIG. 7 is a plot of crystallization kinetics versus temperature for various blends of PARVAN® 1580 and high-melt Fischer-Tropsch waxes. As shown, as more high-melt Fischer-Tropsch wax was included in the blend, the crystallization curves shifted to higher temperatures.

Table 6 below summarizes the fusion behavior obtained when lubricant compositions containing a 1:1 blend of PARVAN® 1580 and high-melt Fischer-Tropsch wax were blended with the PVC base formulations. The lubricant compositions were incorporated as a direct replacement for PPI TR-2 2019 Part A.3-type waxes in the PVC base formulations.

TABLE 6

| | Fusion Time (min) | | | |
|---|---|---|---|---|
| | | | 1:1 (w/w) blend | |
| | Lubricant | | PARVAN ® 1580 | |
| Processing | Composition | | and High-Melt | High-Melt |
| Temperature | Loading | PARVAN ® | Fischer- | Fischer- |
| (° C.) | (phr) | 1580 | Tropsch Wax | Tropsch Wax |
| 185 | 0.9 | — | 3 | no fusion |
| 187.5 | 1 | 2 | 4 | no fusion |
| 190 | 0.9 | 1.5 | 4 | no fusion |
| 195 | 0.9 | — | 2 | 3 |

As shown, the blend facilitated fusion at higher lubricant composition concentrations, when compared to neat high-melt Fischer-Tropsch wax. The blend also improved lubricant coverage upon PVC particles during fusion in comparison to the Fischer-Tropsch wax alone, as evaluated by SEM image analysis (not shown).

Many alterations, modifications, and variations will be apparent to one having ordinary skill in the art in light of the foregoing description without departing from the spirit or scope of the present disclosure and that when numerical limits and numerical upper limits are listed herein, ranges from any lower limit to any upper limit are contemplated.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical Embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method for blending polyvinyl chloride (PVC), comprising:
combining PVC and a lubricant composition to form a mixture, the lubricant composition comprising one or more C₁₈₊ linear alpha olefins (LAOs) having a kinematic viscosity (ASTM D445) of about 4 cSt or less at 135° C., or one or more LAO dimers formed from the one or more C₁₈₊ LAOs, the one or more LAO dimers having an internal olefin and a kinematic viscosity (ASTM D445) of about 6 cSt or less at 135° C.; and
blending the mixture to form a lubricated PVC blend, the mixture comprising an effective amount of the lubricant composition to provide a fusion temperature for the lubricated PVC blend of about 190° C. or below as determined by torque rheometry at 65 rpm.

2. The method of claim 1, wherein the mixture comprises about 2 parts lubricant composition or less per 100 parts PVC.

3. The method of claim 1, wherein the one or more C₁₈₊ LAOs comprise predominantly C₂₀-C₂₄ LAOs, or C₂₄₊ LAOs.

4. The method of claim 1, wherein the one or more C₁₈₊ LAOs have a kinematic viscosity (ASTM D445) of about 1 cSt to about 4 cSt at 135° C.

5. The method of claim 1, wherein the one or more LAO dimers have a kinematic viscosity (ASTM D445) of about 4 cSt to about 5.5 cSt at 135° C.

6. The method of claim 1, wherein the lubricant composition further comprises an algae oil.

7. The method of claim 6, wherein the lubricant composition has a ratio of algae oil:C₁₈₊ LAOs or algae oil:LAO dimers ranging from about 1:1 to about 1:9 on a weight basis.

8. A method for blending polyvinyl chloride (PVC), comprising:
combining PVC and a lubricant composition to form a mixture, the lubricant composition comprising one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D445) before dimerization of about 4 cSt or less at 135° C., or a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together; and
blending the mixture to form a lubricated PVC blend, the mixture comprising an effective amount of the lubricant composition to provide a fusion temperature for the lubricated PVC blend of about 190° C. or below as determined by torque rheometry at 65 rpm.

9. The method of claim 8, wherein the mixture comprises about 2 parts lubricant composition or less per 100 parts PVC.

10. The method of claim 8, wherein the one or more C₁₈₊ LAOs comprise predominantly C₂₀-C₂₄ LAOs, or C₂₄₊ LAOs.

11. The method of claim 8, wherein the lubricant composition has a kinematic viscosity (ASTM D445) of about 8 cSt or less at 135° C.

12. The method of claim 8, wherein the one or more C₁₈₊ LAOs have a kinematic viscosity (ASTM D445) of about 1 cSt to about 4 cSt at 135° C.

13. The method of claim 12, wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.

14. The method of claim 8, wherein a ratio of paraffinic hydrocarbon wax to Fischer-Tropsch wax in the paraffinic hydrocarbon blend ranges from about 9:1 to about 1:1 on a weight basis.

15. The method of claim 14, wherein the paraffinic hydrocarbon blend has a kinematic viscosity (ASTM D445) of about 4.5 cSt to about 7.5 cSt at 135° C.

16. A lubricant composition comprising:
a paraffinic hydrocarbon blend comprising a paraffinic hydrocarbon wax and a Fischer-Tropsch wax, wherein the paraffinic hydrocarbon blend exhibits endothermic melting peaks by differential scanning calorimetry (DSC) that are at least partially merged together.

17. The lubricant composition of claim 16, wherein the paraffinic hydrocarbon wax comprises about 30% branched paraffins or greater on a weight basis.

18. The lubricant composition of claim 16, wherein a ratio of paraffinic hydrocarbon wax to Fischer-Tropsch wax in the paraffinic hydrocarbon blend ranges from about 1:1 to about 9:1 on a weight basis.

19. The lubricant composition of claims 16, wherein the paraffinic hydrocarbon blend has a kinematic viscosity (ASTM D445) of about 4.5 cSt to about 7.5 cSt at 135° C.

20.-24. (canceled)
